(19) United States
(12) Patent Application Publication
(10) Pub. No.: US 2003/0133300 A1
(43) Pub. Date: Jul. 17, 2003

(54) Light absorbing wall for LED package

(76) Inventors: Bily Wang, Hsin-Chu (TW); Bill Chang, Hsin-Chu (TW); Chin-Mau James Hwang, Hsinchu (TW)

Correspondence Address: Hung Chang Lin, 8 Schindler Court, Silver Spring, MD, 20903, US

(21) Appl. No.: 10/044,772

(22) Filed: Jan. 11, 2002

(51) Int. Cl. F21V 5/00

(52) U.S. Cl. 362/327; 362/800

(57) ABSTRACT

The focusing cup of a LED package is coated exteriorly with or made of opaque material to reduce the spurious external light interference due to the reflections of the surfaces of focusing cup.

### BACKGROUND OF THE INVENTION

(1) Field of the Invention

This invention relates to Light Emitting Diodes (LED), particularly the package of the LED.

(2) Brief description of Related Art

FIGS. 1 and 2 show the prior art package for a LED. FIG. 1 shows the top view of such a LED package, and FIG. 2 shows the cross-sectional view along the section line AA′ of FIG. 1 of such a LED package. A LED chip 10 is mounted inside a cup 14 having a wall 12. The light emitted from the LED 10 is subtended by the rays E. Due to reflections of the wall 12, external light may reflect as rays S. Such reflected light rays may interfere with the light rays E from the LED 10. Where the spurious reflected light rays S interfere with the emitted light rays E, a fuzzy region I may appear to change the color of the emitted light E.

### SUMMARY OF THE INVENTION

An object of this invention is to provide a LED package which does not alter the light emitted from a LED. Another object of this invention is to provide a LED package for high quality light emission.

These objects are obtained by coating the exterior wall of the reflecting cup of the LED with opaque material to minimize the spurious light reflection from the exterior walls of the cup, hence the interference of spurious light.

### BRIEF DESCRIPTION OF THE SEVERAL VIEWS OF THE DRAWINGS

FIG. 1 shows the top view of a prior art LED package.

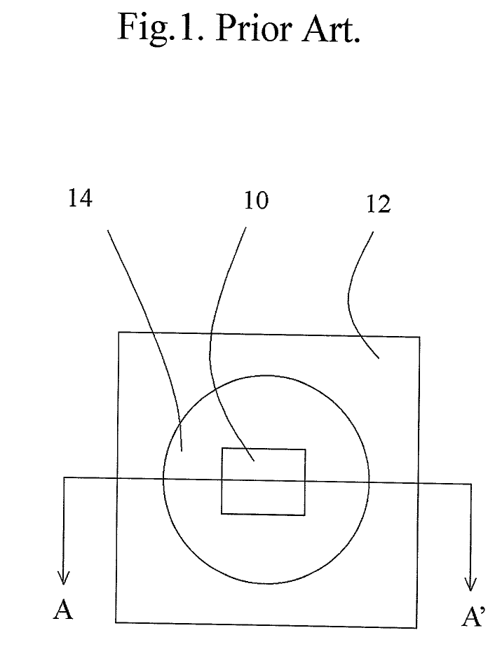

FIG. 2 shows a cross-section view of the LED package shown in FIG. 1.

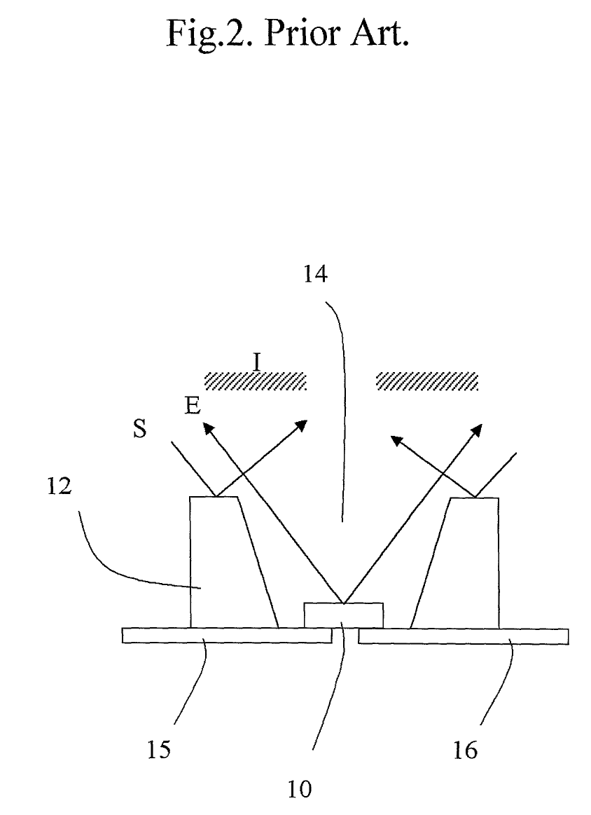

FIG. 3 shows the first embodiment of the present invention with opaque tops of the cup.

FIG. 4 shows a second embodiment of the present invention with partial opaque tops of the cup.

FIG. 5 shows a third embodiment of the present invention with total opaque coating of all exterior surfaces of the cup.

FIG. 6 shows a fourth embodiment of the present invention with partial opaque coating of exterior surfaces of the cup.

FIG. 7 shows a fifth embodiment of the present invention with opaque coating of vertical exterior walls of the cup.

FIG. 8 shows a sixth embodiment of the present invention with partial opaque coating of the exterior vertical walls of the cup.

FIG. 9 shows a seventh embodiment of the present invention with cup made of opaque material.

FIG. 10 shows an eighth embodiment of the present invention with an inverted V-shaped interior of the cup.

FIG. 11 shows a ninth embodiment of a present invention with a cylindrical interior of the cup.

FIG. 12 shows a tenth embodiment of the present invention in which the LED has a top electrode. and a bottom electrode.

FIG. 13(A) shows a oval-shaped cup; FIG. 13(B) shows rectangular cup; FIG. 13(C) shows a hexagonal cup.

### DETAILED DESCRIPTION OF THE INVENTION

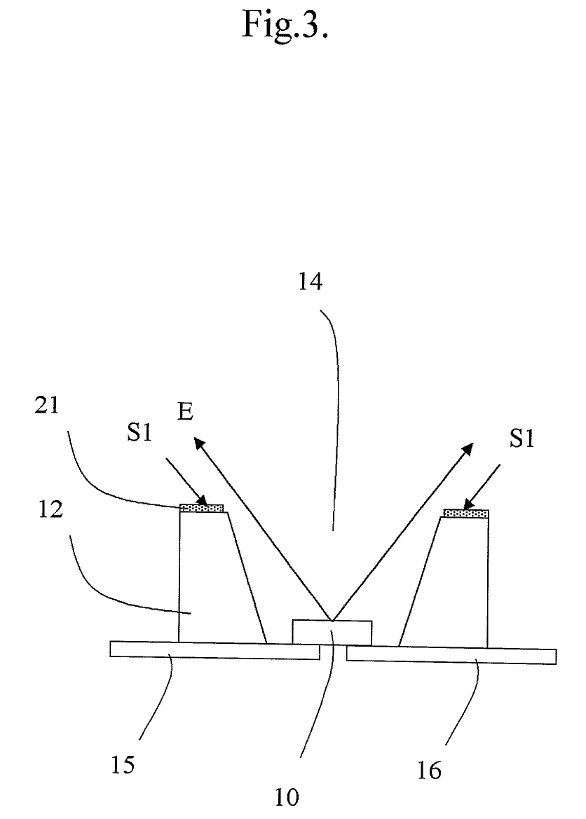

FIG. 3 shows the first embodiment of the present invention. A LED 10 with two bottom electrodes is mounted over two metal leads 15 and 16. The LED 10 is surrounded by a cup 14 with a wall 12 to confine the light emitted from the LED 10. The top surface of the wall 12 is coated with an opaque material 21. The light rays emitted from the LED 10 are subtended by the rays E. Any spurious light S1 incident on the top surfaces of the cup is absorbed and not reflected, because the coating 21 is non-reflective. Thus, the light rays E emitted from the LED 10 are not interfered.

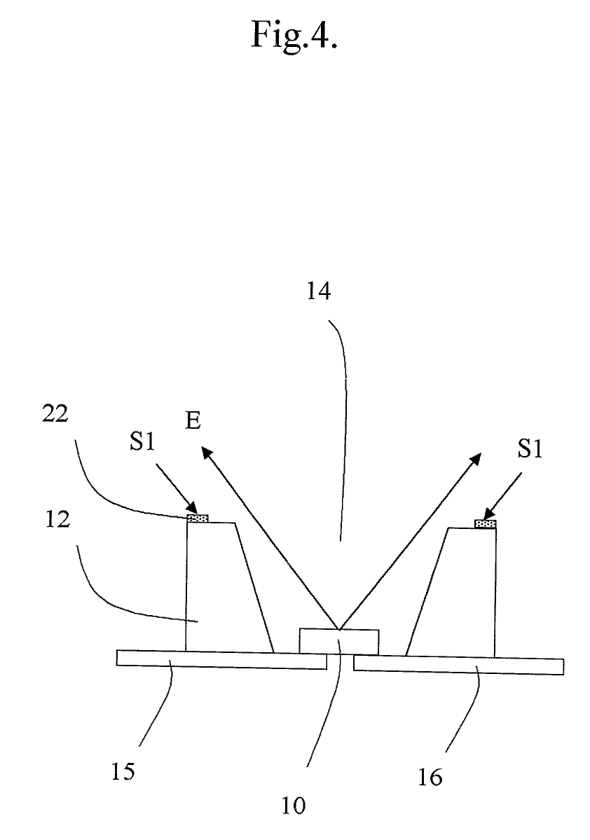

FIG. 4 shows a second embodiment of the present invention. The structure is similar to that in FIG. 3, except that the top surface of the cup 12 is partially covered opaque material 22. The partial coating makes it easier to fabricate.

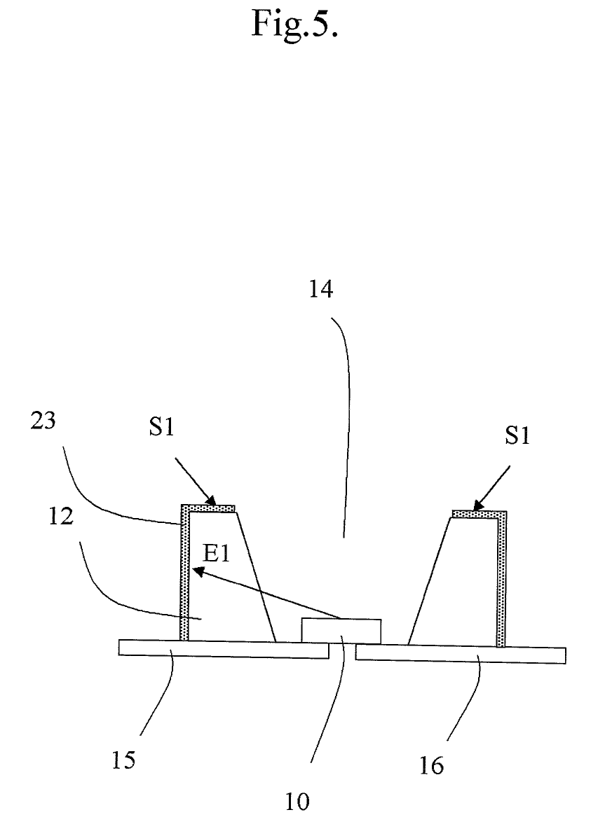

FIG. 5 shows a third embodiment of the present invention. Both the top surface and vertical exterior surface 23 of the cup are coated with opaque material. When the packaging dimensions is shrunk, the thickness of the cup becomes very thin. The light ray E1 emitted from the LED 10 may penetrate through the wall of the cup 12 to cause spurious reflections and hence interference of the emitted light. By coating the vertical exterior side walls of cup 12, this undesirable interference can be avoided.

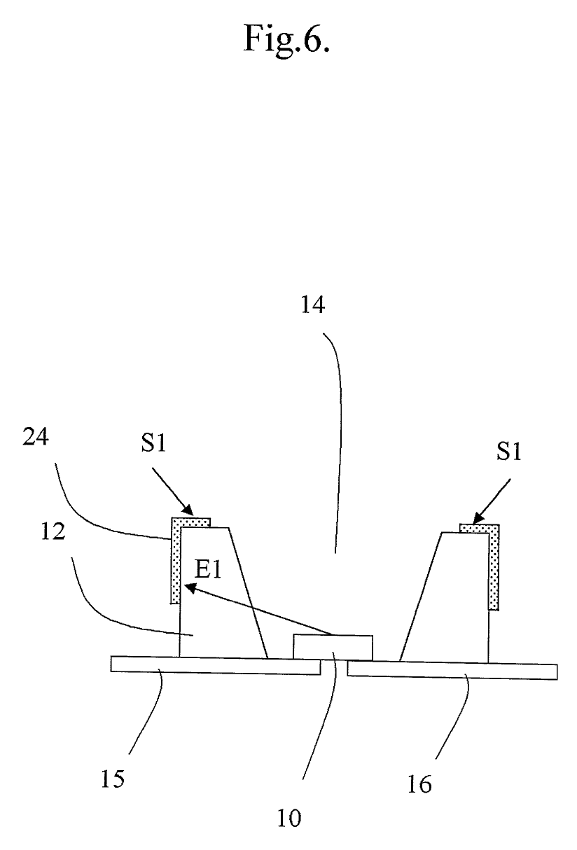

FIG. 6 shows a fourth embodiment of the present invention. The structure is similar to FIG. 5 except that the vertical exterior wall is only partially coated with opaque material 24. The partial coating is for the convenience of fabrication and saving of coating material.

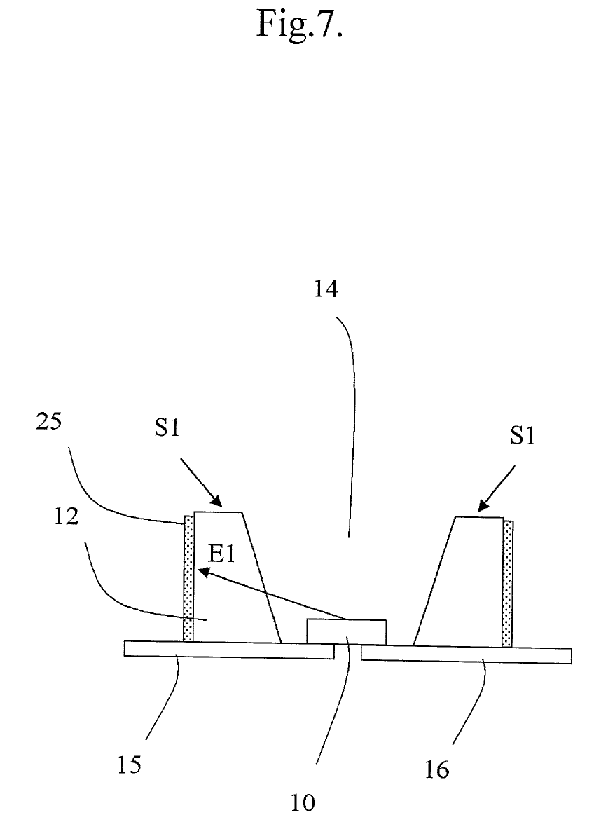

FIG. 7 shows a fifth embodiment of the present invention. The structure is similar to FIG. 5, except that only the exterior vertical wall is coated with opaque material 25. This structure is intended for easy fabrication, saving coating material and different light absorbing properties.

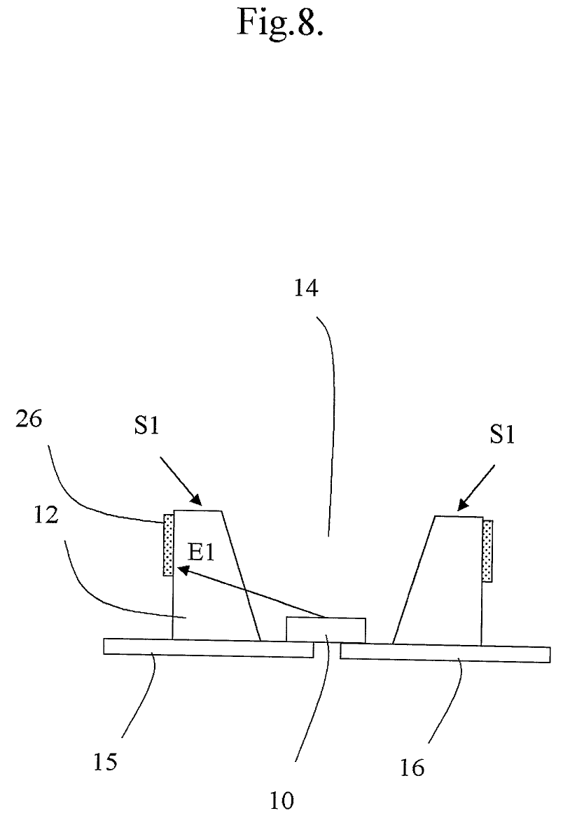

FIG. 8 shows a sixth embodiment of the present invention. The structure is similar to FIG. 7 except that the exterior vertical wall is partially coated with opaque material 26. The structure is intended for easy fabrication, saving coating material and different light absorbing properties.

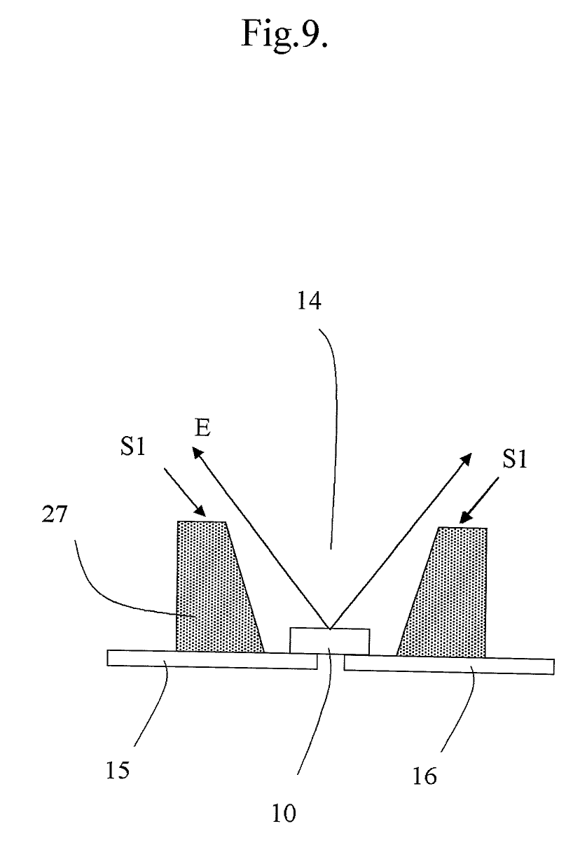

FIG. 9 shows a seventh embodiment of the present invention. The structure is similar to that in FIG. 3 except that the cup 27 is made of solid light absorbing material. With this structure, there can be no spurious reflection from all surfaces of the cup.

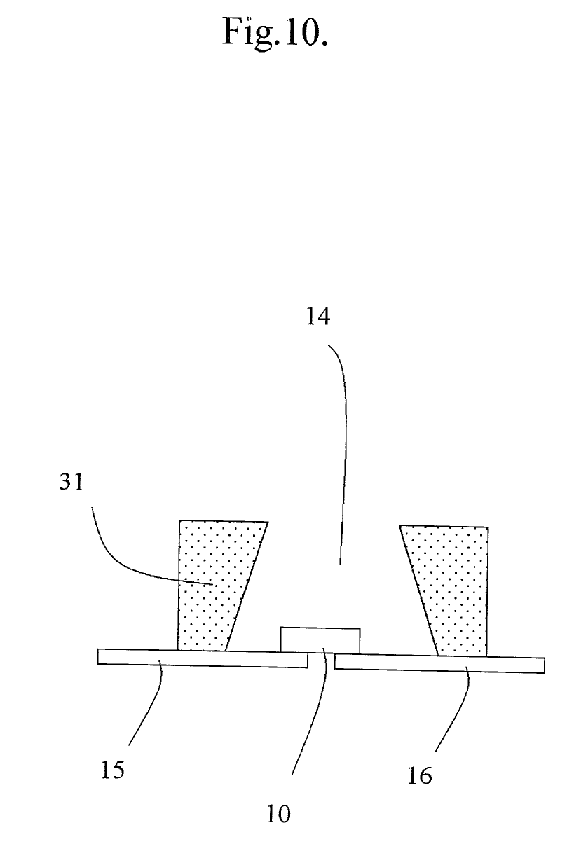

FIG. 10 shows an eighth embodiment of the present invention. The structure is similar to that in FIG. 9, except that the interior wall 31 of the cup 14 is of inverted V-shape.

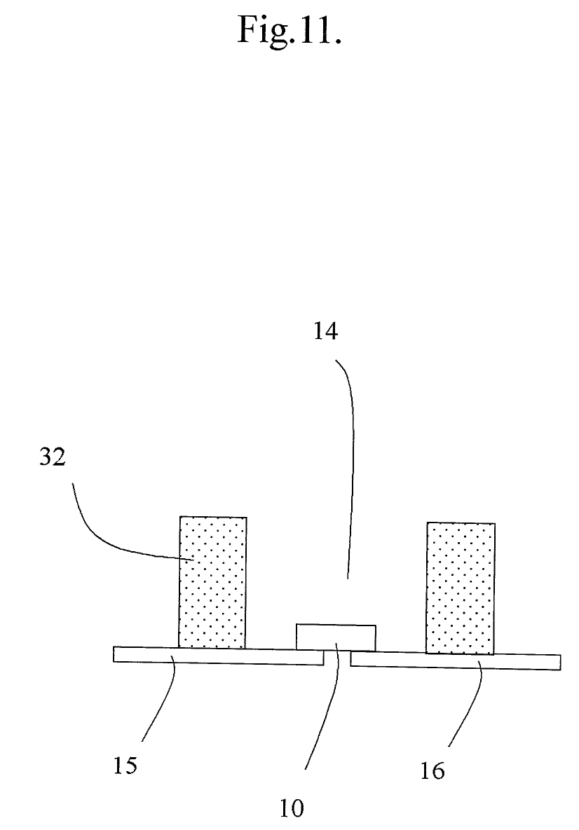

FIG. 11 shows a ninth embodiment of the present invention. The structure is similar to that in FIG. 9, except that the interior wall 32 of the cup 14 is of cylindrical shape.

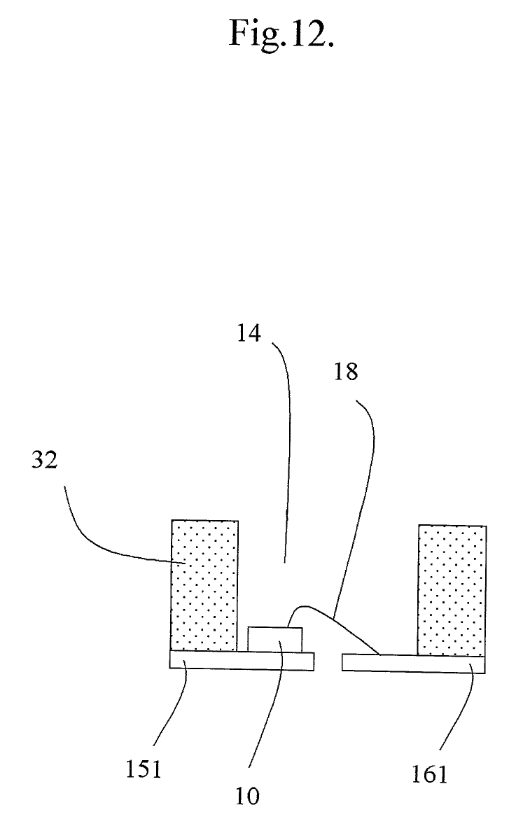

FIG. 12 is a tenth embodiment of the present invention. The structure is similar to that in FIG. 11, except that the LED 10 has a bottom electrode and the top electrode. The bottom electrode is connected to the lead 151 and the top electrode is connected to the lead 161.

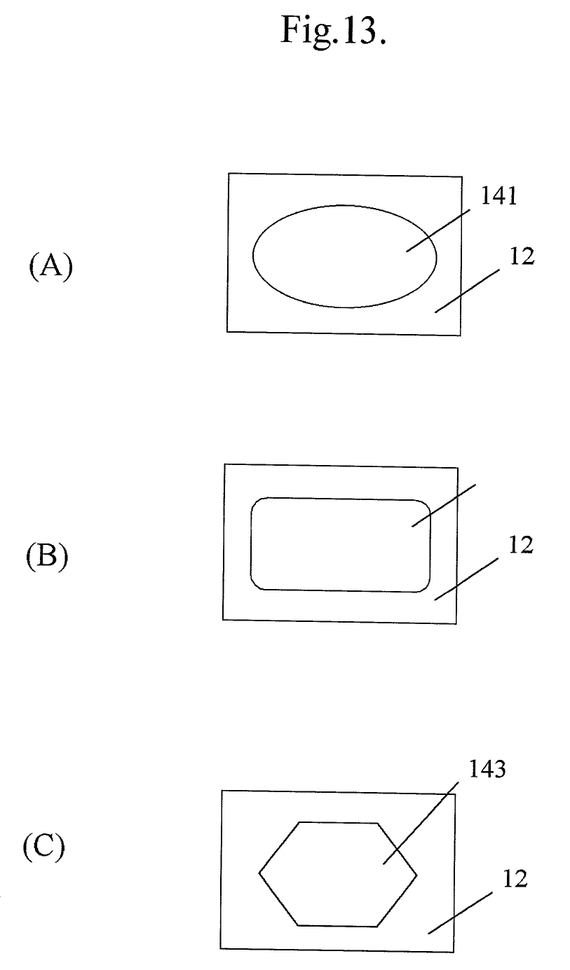

FIG. 13 shows variations of the shape of the wall 12 of the cup in FIG. 3. FIG. 13(A) has a oval shaped cup 141; FIG. 13(B) has a rectangular shaped cup 142; and FIG. 13(C) has a hexagonal shaped cup 143.

While the preferred embodiments of the invention have been described, it will be apparent to those skilled in the art that various modifications can be made in the embodiments without departing from the spirit of the present invention. Such modifications are all within the scope of this invention.

1. A light emitting diode (LED) package, comprising:
a light emitting diode;
external leads for connection to the electrodes of said LED;
a cup mounted on said external leads and surrounding said LED; and
opaque material for coating at least partially exterior wall surface of said cup for decreasing spurious reflections of said exterior wall surface.

2. The LED package as described in claim 1, wherein the top surface of said cup is covered with said opaque material.

3. The LED package as described in claim 1, wherein the top surface of said cup is partially covered with said opaque material.

4. The LED package as described in claim 1, wherein the entire exterior surface of said cup is covered with said opaque material.

5. The LED package as described in claim 1, wherein partial top surface of said cup and partial vertical exterior surface of said cup are covered with said opaque material.

6. The LED package as described in claim 1, wherein only the vertical exterior wall of said cup is coated with said opaque material.

7. The LED package as described in claim 1, wherein only the vertical wall of said cup is partially coated with said opaque material.

8. The LED package as described in claim 1, wherein said cup is made of said opaque material.

9. The LED package as described in claim 1, wherein the inside wall of said cup is of inverted-V shape.

10. The LED package as described in claim 1, wherein the inside wall of said cup is of cylindrical shape.

11. The LED package as described in claim 1, wherein said LED has a bottom electrode connected one of said leads and a top electrode wire-bonded to a second of said leads.

12. The LED package as described in claim 1, wherein the interior wall surface of said cup is of oval shape.

13. The LED package as described in claim 1, wherein the interior wall surface of said cup is of rectangular shape.

14 the LED package as described in claim 1, wherein the interior wall surface of said cup is of hexagonal shape.
